(19) United States
(12) Patent Application Publication
(10) Pub. No.: US 2011/0239791 A1
(43) Pub. Date: Oct. 6, 2011

(54) SYSTEM AND METHOD FOR BIOLOGICAL SAMPLE STORAGE AND RETRIEVAL

(76) Inventor: Dolores Fici, Revere, MA (US)

(21) Appl. No.: 13/015,235

(22) Filed: Jan. 27, 2011

Related U.S. Application Data
(60) Provisional application No. 61/398,832, filed on Jul. 1, 2010.
(60) Provisional application No. 61/337,036, filed on Jan. 29, 2010.

(51) Int. Cl. B01L 3/00

(52) U.S. Cl. 73/863.11; 73/864.91

(57) ABSTRACT

Aspects of the invention are directed to a sample vial comprising a container configured to receive a sample, the container having a top portion and a cap configured to mate with the top portion of the container, the cap having a magnetic component. In some embodiments the sample vial is configured for storage of a biological sample in an ultralow temperature environment. In other embodiments, a sample vial is provided comprising a cylindrical body, having a first and second end, the first and second ends having a narrow aperture extending through the cylindrical body, wherein the cylindrical body has a long length relative to a diameter of the narrow aperture and a magnetic component. Further aspects are directed to retrieval of sample vials using the magnetic component, and fabrication of magnetic components for use with various sample vials. A magnetic retrieval rod can be used to couple the magnetic component.

### CROSS-REFERENCE TO RELATED APPLICATIONS

This application claims priority under 35 U.S.C. §119(e) to U.S. Provisional Application Ser. No. 61/398,832 entitled “‘MAG-CAP’ BIOLOGICAL SAMPLE STORAGE AND RETRIEVAL SYSTEM,” filed Jul. 1, 2010, and U.S. Provisional Application Ser. No. 61/337,036 entitled “‘MAG-CAP’ BIOLOGICAL SAMPLE RETRIEVAL SYSTEM,” filed Jan. 29, 2010, both of which applications are herein incorporated by reference in their entirety.

### BACKGROUND

1. Field of the Invention

The present disclosure is directed to biological sample storage vials, and more specifically to retrieval of sample vials using magnetic components in ultralow temperature environments.

2. Related Art

Maintenance of biological sample integrity and viability for long periods of storage time is best facilitated with compatible cryopreservation tubes, reagents, and ultralow temperature storage. Most commonly, ultralow temperature storage employs liquid nitrogen in various storage systems. Many available sample freezer inventory systems (ultralow temperature storage systems) do allow for easy identification of sample identity and location on sample vials used for storage. Conventional sample vials are readily commercially available for modest costs.

For the majority of biological or cellular samples, viability is best preserved and maintained at approximately −140° C. in the vapor or liquid phase of nitrogen, an example of an ultralow temperature environment. The level of liquid nitrogen is usually monitored and measured daily to assure laboratory compliance. The presence of liquid nitrogen and the low temperatures required to maximize viability of the stored sample present significant hazards to managing storage of the sample vials. One conventional approach to facilitate storage and management of sample vials includes the use of colored tags inserted into the sample vials to aid in subsequent location and identification.

### SUMMARY

Occasionally, a sample vial of interest may be inadvertently dropped or misplaced into the liquid phase of nitrogen. The challenge to retrieve the sample vial is significant and most often retrieval becomes a futile effort. As liquid nitrogen is used as the cooling medium, lost or misplaced sample vials are typically obscured by impenetrable mist/fog vapors present at the liquid nitrogen-air interface and human operators are unable to visually locate the vial. Moreover the danger of contacting the liquid nitrogen medium is greatly increased during any attempts at blind fishing expeditions into the storage environment. It is to be appreciated that no tools have been developed and/or designed for the purpose of misplaced vial rescue or re-capture from ultralow temperature storage. Most laboratories have no alternative but to improvise crude devices in an attempt to retrieve sample vials, however, such ad hoc devices are not always successful at retrieving sample vials from the cooling medium. In some examples, kitchen utensils have been used to attempt retrieval. The loss associated with failed retrieval can be significant. Augmenting sample vials for safe and effective retrieval provides significant advantage.

According to one aspect of the present invention, a sample vial is provided. The sample vial comprises a container configured to receive a sample, the container having a top portion, and a cap configured to mate with the top portion of the container, the cap having a magnetic component. According to one embodiment of the present invention, the magnetic component comprises a filler component, and a magnetic element, wherein the magnetic component is constructed and arranged to fit within the cap of the sample vial. According to another embodiment of the invention, the mated container and cap are constructed and arranged to store a biological sample in an ultralow temperature environment. According to another embodiment of the invention, the ultralow temperature environment comprises a nitrogen cooled environment. According to another embodiment of the invention, the cap further comprises a top surface, and an outer wall having a circumference and a depth, wherein the circumference and the depth of the outer wall define a boundary of an opening on the top surface of the cap configured to receive the magnetic component. According to another embodiment of the invention, the magnetic component is constructed and arranged to fit within the boundary of the opening on the top surface of the cap.

According to one embodiment of the present invention, the magnetic component is constructed and arranged to removeably fit within the boundary of the opening on the top surface of the cap. According to another embodiment of the invention, the magnetic component further comprises at least one ventilation hole extending through the magnetic component. According to another embodiment of the invention, the top portion of the container further comprises a threaded portion, wherein the cap further comprises a threaded portion, and wherein the cap and the container are constructed and arranged to mate at the threaded portions. According to another embodiment of the invention, the filler component further comprises at least one of an epoxy, a composite resin, resin, polycarbonate material, acrylonitrile butadiene styrene, polyethylene foam, polypropylene foam, and a copolymer foam. According to another embodiment of the invention, the magnetic element comprises at least one of a ferromagnetic material and a permanent magnet.

According to one aspect of the present invention, a sample vial is provided. The sample vial comprises a cylindrical body, having a first end and a second end, the first and second ends having a narrow aperture extending through the cylindrical body, wherein the cylindrical body has a long length relative to a diameter of the narrow aperture, and a magnetic component contained in the cylindrical body. According to one embodiment of the present invention, the narrow aperture extending through the cylindrical body defines a storage volume for the sample vial, wherein at least part of the storage volume is configured for receiving and storing a biological sample in an ultralow temperature environment. According to another embodiment of the invention, the magnetic component includes a magnetic element, and the magnetic element comprises at least one of a ferromagnetic material and a permanent magnet. According to another embodiment of the invention, the magnetic component further comprises a filler component, and the filler component comprises at least one of an epoxy, a composite resin, resin, polycarbonate material, acrylonitrile butadiene styrene, polyethylene foam, polypropylene foam, and a copolymer foam. According to another embodiment of the invention, the cylindrical body further comprises at least one plug positioned within the storage volume, wherein the at least one plug is permeable to air, and wherein the magnetic component is positioned between the at least one plug and one of the first and second ends of the cylindrical body. According to another embodiment of the invention, at least one of the first and second ends of the cylindrical body is constructed and arranged to be sealable using heat. According to another embodiment of the invention, a shape of the magnetic component is at least one of a cylinder and a sphere.

According to one aspect of the present invention, a method for retrieving sample vials from an ultralow temperature environment is provided. The method comprises storing a biological sample in an ultralow temperature environment in a sealable sample vial, the sealable sample vial having a magnetic component, and retrieving, by a human operator, at least one sealable sample vial from the ultralow temperature environment, wherein the act of retrieving includes an act of capturing the at least one sample vial employing the magnetic component. According to another embodiment of the invention, the method further comprises an act of inserting a magnetic component into at least one of a cap of the sealable sample vial and a sealable end of the sealable sample vial. According to another embodiment of the invention, the act of inserting the magnetic component further comprises an act of distending a portion of the sealable sample vial. According to another embodiment of the invention, the magnetic component further comprises at least one of a ferromagnetic material and a permanent magnet. According to another embodiment of the invention, the act of capturing the at least one sealable sample vial includes an act of placing, by a human operator, a retrieval rod proximate to the at least one sample vial, wherein the retrieval rod includes a magnetic component. According to another embodiment of the invention, storing the biological sample in the ultralow temperature environment in the sealable sample vial includes storing a plurality of sealable sample vials in holding structures within the ultralow temperature environment, and wherein retrieving the at least one sample vial from the ultralow temperature environment includes retrieving the at least one sealable sample vial from a position within the ultralow temperature environment outside of the holding structures. According to another embodiment of the invention, the magnetic component is spherical. According to another embodiment of the invention, the position outside of the holding structures is at least one of an unknown position and a visually obscured position.

According to one aspect of the present invention, a method for manufacturing magnetic sample vials is provided. The method comprises providing a sample vial having an opening configured for storage of a biological sample in an ultralow temperature environment, and inserting a magnetic component into the opening of the sample vial, wherein the magnetic component is constructed to fit within the opening. According to one embodiment of the present invention, the opening is defined in at least one of a cap of the sample vial and a sealable end of the sample vial. According to another embodiment of the invention, the method further comprises an act of fabricating the magnetic component based on a determined size of the opening. According to another embodiment of the invention, the act of inserting the magnetic component includes fabricating the magnetic component within the opening. According to another embodiment of the invention, the act of fabricating the magnetic component includes an act of combining a filler component and a magnetic element. According to another embodiment of the invention, the filler component includes at least one of an epoxy, a composite resin, resin, polycarbonate material, acrylonitrile butadiene styrene (ABS), polyethylene foam, polypropylene foam, and a copolymer foam and the magnetic element includes at least one of a ferromagnetic material and a permanent magnet. According to another embodiment of the invention, the act of inserting the magnetic component further comprises an act of distending a portion of the sample vial. According to another embodiment of the invention, the act of fabricating the magnetic component further comprises an act of establishing at least one ventilation hole in the magnetic component.

According to one aspect of the present invention, a retrieval system is provided. The retrieval system comprises a container configured to receive a sample, the container having a top portion, a cap configured to mate with the top portion of the container, the cap having an upper portion, and a magnetic component constructed and arranged to be inserted into the upper portion of the cap. According to one embodiment of the present invention, the retrieval system also comprises a retrieval rod having a magnetic component on at least one end, the magnetic component of the retrieval rod having an opposite polarity of the magnetic component of the cap. According to another embodiment of the invention, the magnetic component further comprises a filler component, and a magnetic element. According to another embodiment of the invention, the magnetic element comprises at least one of a ferromagnetic material and a permanent magnet. According to another embodiment of the invention, the filler component is constructed and arranged to fix the magnet into position within the magnetic component, and fix the magnetic component into position within the cap.

According to one embodiment of the present invention, the magnetic component is fixed in position by pressure exerted between the magnetic component and the cap. According to another embodiment of the invention, the magnetic component is fixed in position by a bond formed between the magnetic component and the cap. According to another embodiment of the invention, the filler component further comprises at least one of an epoxy, a composite resin, resin, polycarbonate material, and foam. According to another embodiment of the invention, the magnetic component further comprises at least one ventilation hole extending through the magnetic component. According to another embodiment of the invention, the cap further comprises a cavity defined by the upper portion of the cap, wherein the magnetic component is constructed and arranged to fit within the cavity.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A illustrates one example of a conventional sample vial used in ultralow temperature environments, according to aspects of the invention;

FIG. 1B illustrates an example of a sample vial configured for magnetic retrieval, according to aspects of the invention;

FIG. 1C illustrates a perspective view of a cap into which a magnetic component can be inserted, according to aspects of the invention;

FIG. 2A illustrates an example retrieval tool 200 that permits magnetic capture of sample vials, according to aspects of the invention;

FIG. 2B illustrates a retrieval operation performed on a sample vial within an ultralow temperature environment, according to aspects of the invention;

FIGS. 3A-D illustrate examples of embodiments of an insertable magnetic component, according to aspects of the invention;

FIG. 4 illustrates an example holding structure for sample vials, according to aspects of the invention;

FIG. 5 illustrates and an example ultralow temperature storage tank, according to aspects of the invention;

FIG. 6 illustrates examples of cylindrical body sample vials, according to aspects of the invention;

FIG. 7 illustrates examples of sample vials having a cylindrical body, according to aspects of the invention;

FIGS. 8A-B illustrate an exploded view of an example sample vial having a cylindrical body, according to aspects of the invention; and

FIG. 9 illustrates an example sample vial, according to aspects of the invention.

### DETAILED DESCRIPTION

According to one aspect, commercial sample vials are augmented for ready retrieval in ultralow temperature environments. Some typical sample vials are constructed of plastic of sufficient tolerance to withstand an ultralow temperature environment (e.g., −140° C. to −196° C.). In one embodiment, standard sample vials are constructed and arranged in two parts having a container and a cap. The container portion of the vial typically includes an upper portion configured to mate with the cap. The mated container and cap seal a sample for storage in the ultralow temperature environment. In some settings, a biological sample is kept in the ultralow storage environment for extended periods of time. Known sample vials include marking cavities in the cap portion of the vial to assist in identification and labeling of sample vials. In some examples, the cap includes an empty cylindrical space at the top of the cap in which colored inserts or plugs can be placed to mark the sample vial. One example of a sample vial includes, Corning Cryogenic Vial, supplied by Corning, under part no. 430658.

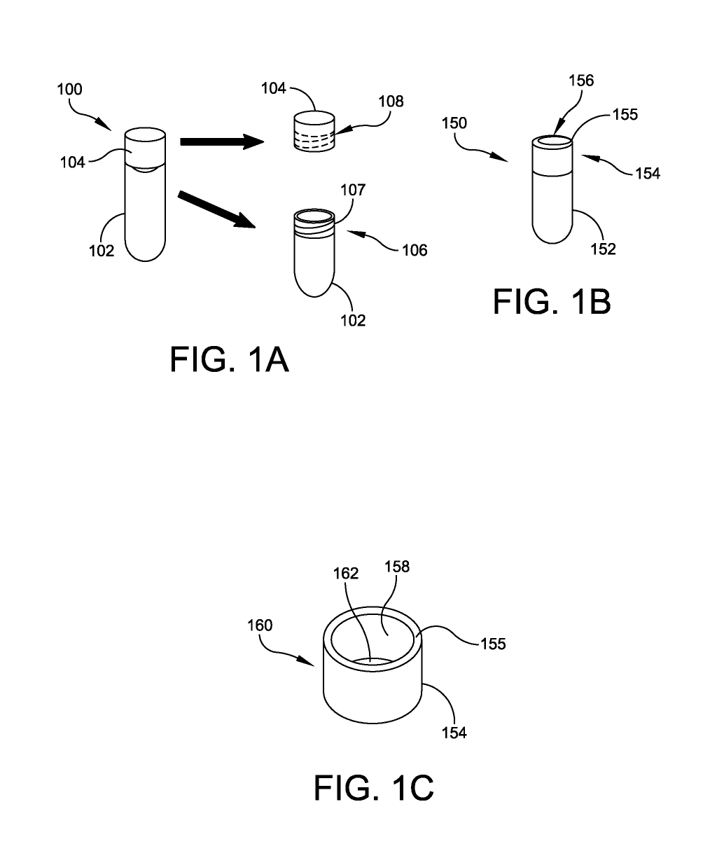

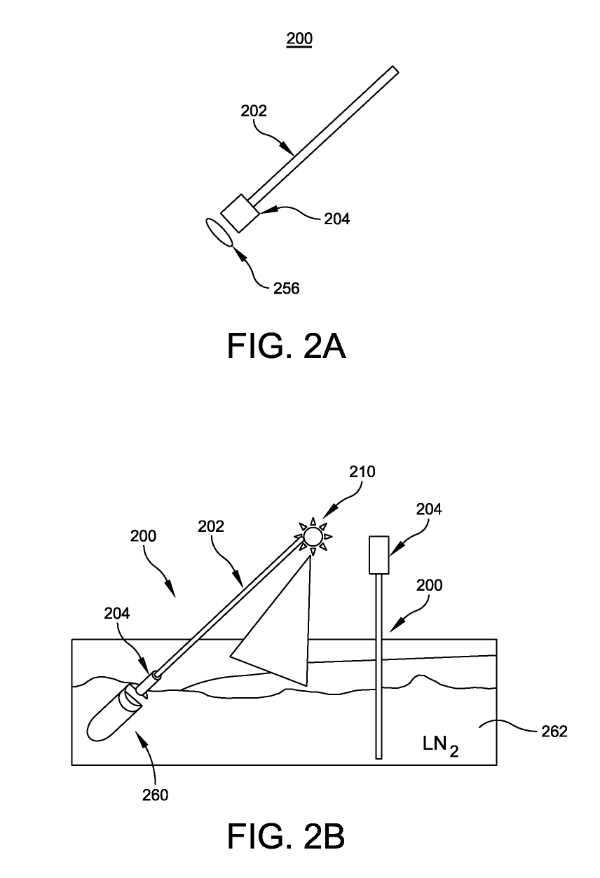

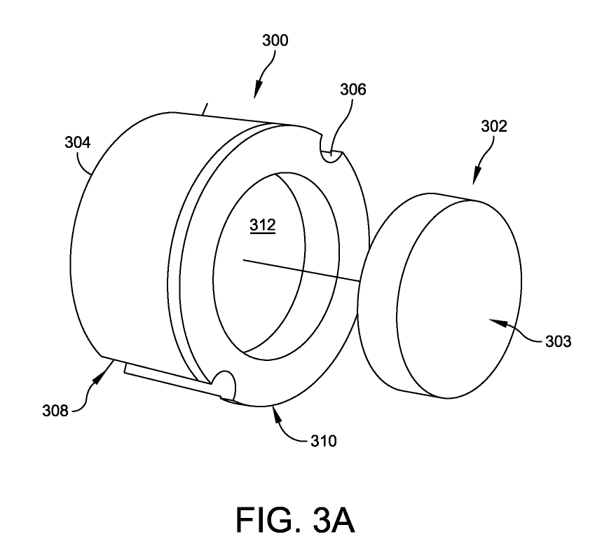

Shown in FIG. 1A, is an example of a conventional sample vial used in ultralow temperature environments. Sample vial 100, is assembled from a container portion 102 and a cap portion 104. Once container 102 and cap 104 are mated any sample, typically a preserved biological sample, can be stored in an ultralow temperature environment. Sample vial 100 illustrates an example vial where container 102 and cap 104 have opposed threaded portions to mate the container 102 and cap 104. Shown in FIG. 1A, container 102 includes an upper portion 106. Upper portion 106 includes a structure configured to mate with a structure on cap 104. In some embodiments, upper portion 106 includes external threads 107 that are constructed and arranged to mate with internal threads 108 on cap 104. In other embodiments (not shown), the container 102 can include internal threads which mate with external threads on cap 104. Other mating structures can be constructed on the container 102 and cap 104 to provide the seal between the container 102 and cap 104, and can include, for example, detents, key and lock structures, and channel and lock structures. In some examples, a gasket and/or washer can be used at a point of contact between the container 102 and cap 104 to insure a better seal. For caps 104 with internal threads the gasket or washer can be inserted into the cap so the container 102 comes into contact with the gasket or washer upon mating. For caps with external threads the gasket or washer can fit over the external threaded portion so the container comes into contact with the gasket or washer for an improved seal.

Shown in FIG. 1B, is an example of a sample vial 150 configured for magnetic retrieval, for example, when lost or misplaced in an ultralow temperature environment. Vial 150 includes a container 152 and cap 154 which are constructed to mate to hold a biological sample for storage in an ultralow temperature environment. In some embodiments, cap 154 is previously constructed with a cavity in an upper surface 155 of the cap 154. A magnetic component is inserted into the cavity in the upper surface 155. Shown in greater detail in FIG. 1C, is a perspective view of cap 154 having an upper surface 155 and a cavity 158 into which a magnetic component can be inserted. Conventional caps used for storage in ultralow temperature environments (“cryostorage”) are constructed with cavities 158. However in conventional sample vials, the cavity is constructed to receive colored label inserts. The colored label inserts assist in identification of sample vials and management of the sample vial inventory. In at least one embodiment of the present invention a magnetic component inserted into the cap configures conventional sample vials for retrieval from any location in an ultralow temperature environment, and more particularly, from unknown, unidentified, and/or unexpected positions.

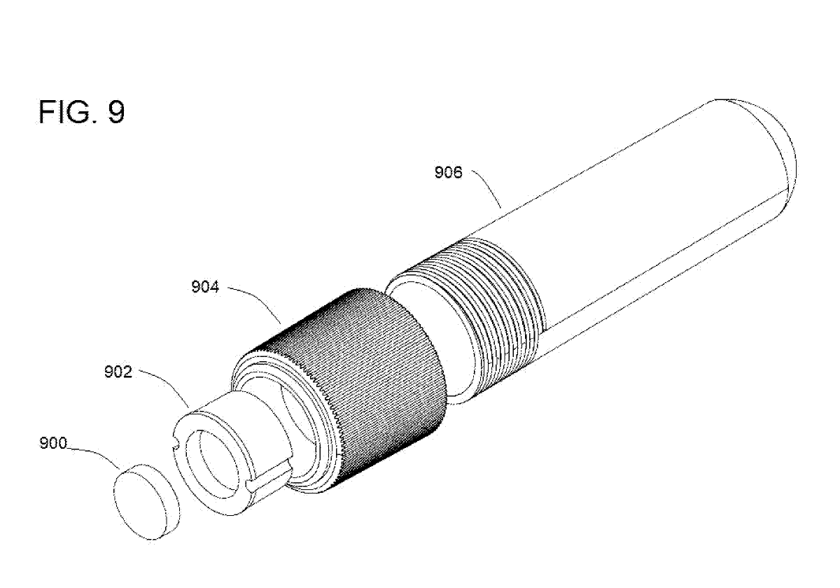

Shown in FIG. 9 is another example sample vial having a magnetic element 900 and filler material 902, which are arranged to fit within an opening of a cap 904. The cap is configured to mate with a container 906 to seal a sample within the sample vial.

In some examples, fabricating and inserting magnetic components into, for example, cavity 158 permits magnetic retrieval of sample vials when the vials have become lost, are not within an expected position, or have fallen out of a storage structure within the ultralow temperature environment. Once configured for retrieval the retrieval of sample vials is possible from the within the cooling medium itself. For example, when sample vials fall into the cooling medium of the ultralow temperature environment, a laboratory technician can retrieve the sample vial using a magnetic retrieval rod. In some embodiments, the retrieval rod is configured with a magnetic portion having an opposed magnetic polarity to the magnetic component of the cap.

According to one embodiment, a magnetic component can be fabricated for insertion into any cavity defined in the upper surface of a sample vial cap. Typically the cavity forms an empty cylindrical space, as illustrated in FIG. 1C at 158. Cap 154 includes an outer wall 160 having a circumference that extends around the entirety of the cap 154 and a depth that extends to a bottom surface 162 within the cavity. The circumference and the depth define an outer boundary for the cavity 158. The cavity is typically cylindrical, but other configurations can be employed. The other configurations can include sloped walls, detents and/or protrusions formed on the cap's outer wall 160 to assist in holding a magnetic component in place. In some examples, a bottom portion of the cavity can be larger than an upper portion, which assists in holding the magnetic component in place.

In some settings, fabrication of the magnetic component can be accomplished at a laboratory using retrieval upgrade kits that include filler material and magnetic elements sized for the standard opening in the cap. The filler material and magnetic elements can be used to construct a magnetic component. The magnetic element can be a ferromagnetic material or a permanent magnet placed in the open space of the cap with the filler material. In some examples the ferromagnetic material or permanent magnet can be sized to fit within a cavity of the cap by itself. In other examples, the ferromagnetic material or permanent magnet are sized to fit within a cavity of a cap with clearance. The filler material is used to fill any void space left in the cavity to form a magnetic component for the sample vial. The filler material can be a resin, epoxy, composite resin, polycarbonate, acrylonitrile butadiene styrene (ABS), and various foam inserts (e.g. polyethylene foam, polypropylene foam, and a copolymer foam), or other plastics suitable for ultralow temperatures. In some examples, the magnetic element can be mixed with the filler material to form the magnetic component. In one example, the magnetic element can be a particulate form of a ferromagnetic material or permanent magnet. The particulate can be mixed with the filler material to fabricate a magnetic component. Once the filler material and magnetic element are in place, the standard sample vial has been modified for magnetic retrieval.

In some settings, the filler material can require curing and/or drying before the sample vial can be used in the ultralow temperature environment. In some embodiments, ventilation holes can be constructed within the magnetic component before or after curing to insure the magnetic component is not forcibly expelled from the cap due to moisture or other material that reacts to the ultralow temperature in which the vial is stored. In some embodiments, the magnetic component is held in position within the cap by pressure exerted between the cap wall and the magnetic component. In some embodiments, the filler material can form structural and/or chemical bonds with the cap holding the magnetic component in place.

In other embodiments, a retrieval upgrade kit includes prefabricated magnetic components constructed to be inserted in a standard sized opening of a sample vial. Prefabricated magnetic component inserts can also be constructed of a magnetic element and a filler material. According to one embodiment, the magnetic component is designed to be inserted into the cap of a standard sample vial and to be held in place by pressure. Although in some examples, a magnetic element alone can be sized to pressure fit within a cavity defined in an upper surface of a cap of a sample vial. Some retrieval upgrade kits can include prefabricated magnetic components of various sizes to accommodate differently constructed openings in a sample vial cap. The various sized magnetic components are configured to accommodate the openings of various commercially available sample vials. In some examples, the magnetic component can include a sleeve that fits around the exterior circumference of the magnetic component to allow an individual magnetic component to pressure fit within a number of differently sized cavities. The sleeve can be constructed and arranged of a plastic material. Materials suitable for constructing the sample vials and magnetic components can be used to construct sleeves as well.

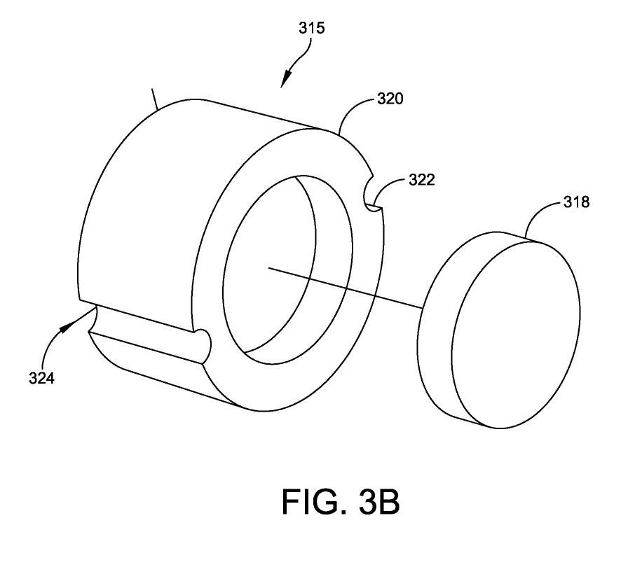

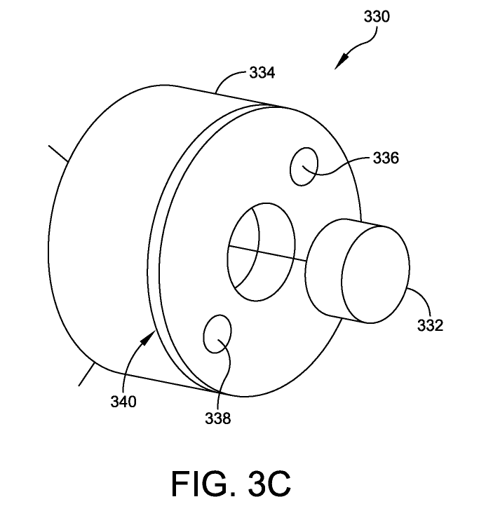

According to one aspect, sample vials configured for magnetic retrieval are suited for use in cryopreservation laboratories. Shown in FIG. 2A, is an example retrieval tool 200 that permits capture of sample vials from within an ultralow temperature storage environment. Sample vial retrieval tool 200 is constructed of a rod portion 202 and a magnetic tip 204. According to one embodiment, the rod portion 202 is constructed of fiberglass connected to the magnetic tip 204. In other examples, the rod portion can be made of phenolic, G10, and other hard plastics suitable for liquid nitrogen immersion. The magnetic tip 204 is constructed to attract magnetic components of sample vials in the storage environment, for example magnetic component 256. In some embodiments, the magnetic tip 204 of the retrieval rod 200 is constructed with an opposed polarity to that of the magnetic components of the sample vials to improve the magnetic force exerted between the sample vials and the retrieval rod 200. Shown in FIG. 2B is an illustration of a retrieval operation performed on a sample vial 260, which has fallen into the cooling medium of the ultralow temperature environment, 262 liquid nitrogen. The sample vial 260 can float within the liquid phase of the cooling medium and still be retrieved using retrieval rod 200. The retrieval rod 200 can also be configured to perform operations that assist in maintaining a proper ultralow temperature environment. In some examples, the retrieval rod 200 can include a light source 210 and hash markings to assist in determining a level of the cooling medium (e.g. liquid nitrogen) within the ultralow temperature environment.

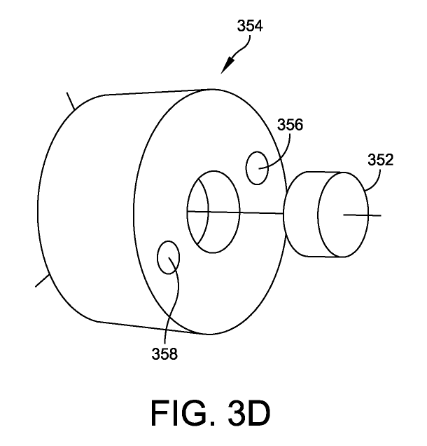

Shown in FIGS. 3A-D are examples of embodiments of an insertable magnetic component. The insertable magnetic components can be fabricated separately from sample vials and used in sample vial upgrade kits. The insertable magnetic component can also be fabricated directly within sample vials. Shown in FIG. 3A is an example insertable magnetic component 300 for use with conventional sample vials. Insertable magnetic component 300 includes a magnetic element 302, which can be made from a ferromagnetic material and/or a permanent disk magnet. In some examples, the permanent disk magnet can be constructed from rare earth metals. The permanent disk magnet can also be constructed to present a primary polarity on its upper surface 303. According to one embodiment, the magnetic element 302 is held in place by a filler component 304. The magnetic element can be constructed to fit within the filler component at 312. In other embodiments, the magnetic element can be seeded within the filler component (not shown). The filler component 304 and/or magnetic element are constructed so that the magnetic component pressure fits within a conventional sample vial cap.

A variety of materials can be used to construct the filler component 304. In some examples, an epoxy can be used. In others a resin, polycarbonate, thermosetting plastic, or foam can be used to construct the filler component 304. The structure of the filler component 304 can be molded to fit within various spaces defined with a variety of caps for a variety of sample vials. In some settings, the filler component 304 can be constructed within the caps themselves during the fabrication process of the sample vials. In other settings, molds can be constructed which are used to fabricate filler components and/or magnetic elements to achieve a variety of insertable magnetic components.

In some embodiments, the insertable magnetic component includes at least one ventilation hole at 306 and/or 308. The ventilation holes 306-308 assist with venting of any trapped gasses and/or moisture that could force the insertable magnetic component out of a cap when a sample vial is introduced into an ultralow temperature environment, or even immersed in the cooling medium of the ultralow temperature environment. Insertable magnetic component 300 can also include an optional assembly ridge 310 mirroring structures within an intended sample vial cap. The assembly ridge 310 is constructed to improve the fit of the insertable magnetic component within the cap of the sample vial. Shown in FIG. 3B, is another example magnetic component 315. The magnetic component 315 includes a magnetic element 318, a filler component 320, ventilation holes 322-324, and does not include the assembly ridge of magnetic component 300. According to some embodiments, ventilation holes can be constructed in a variety of shapes, including channels and/or groves as well as full holes.

FIGS. 3C-3D illustrate example magnetic components 330 and 350 having magnetic elements 332 and 352, filler components 334 and 354, and ventilation holes 336-338 and 356-358. Magnetic components 330 and 350 can be sized to include a variety of magnetic components and can be constructed to have an overall size to fit within a variety of caps of conventional and/or custom sample vials. Further magnetic component 330 can include additional structures, e.g. assembly ridge 340, that minor structures within any sample vial cap. The specific configurations of magnetic components 300, 315, 330, and 350 are shown by way of example and should not be read as limiting the invention to an identical structure. Indeed, a variety of sizes and shapes of magnetic components can be used in a sample vial storage and retrieval system. Some examples, include magnetic components with sloped outer walls.

According to one example, a “Mag-Cap” Biological Sample Storage and Retrieval System is provided. In the system, biological samples are prepared for cryopreservation and then stored in cryogenic vials that have been modified with a ferromagnetic component that is incorporated into the vial. When a modified vial is “lost” a rod or retriever tool with opposite magnetic polarity may be used to “fish” or capture it. Since the level of magnetic or electromagnetic force is not significantly affected by ultra-low temperature, a magnetic capture system may be used to efficiently and safely retrieve or rescue misplaced sample vials that have been modified to include magnetic components.

In one embodiment, the “Mag-Cap” Biological Sample Storage and Retrieval System includes two components: 1.) the “Mag-Cap” Biological Sample Vial and 2.) the “Mag-Cap” Sample Retrieval Rod 1.) In one embodiment, the “Mag-Cap” Biological Sample Vial may be made by modifying a standard sample freezing vial or cryovial. A ferromagnetic component or permanent disk magnet is incorporated into the tube or vial. This vial modification makes it possible to easily recover a “missing” or accidently misplaced vial using magnetic capture or the strong magnetic or electromagnetic force of opposite polarity incorporated into the tip of the “Mag-Cap” Sample Retrieval Rod. The major advantages of the retrieval system in accordance with at least one embodiment include 1) it does not require the visual observation or actual location identification of the misplaced vial on the surface of the liquid nitrogen and 2) successful recovery is non-hazardous, efficient and simple. It should be noted that the polarity of the magnet attached to the vial and the magnet at the end of the sample retrieving tool or rod should have opposite polarity to assist in retrieval from the ultralow temperature environment.

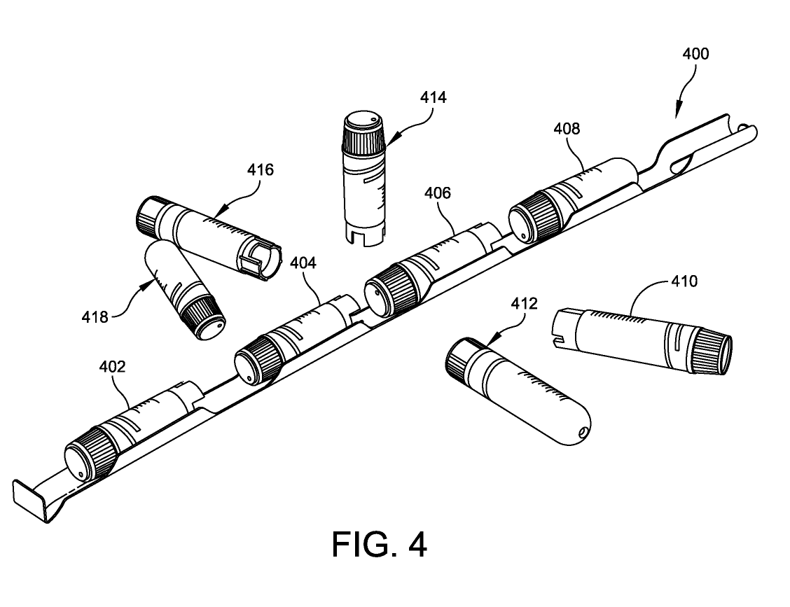

Various ultralow temperature environments can include specially configured holding structures that optimize storage space and permit placement of sample vials at various positions within the ultralow temperature environment. Some examples include cages, canes, storage sleeves, etc. Shown in FIG. 4 is an example cane 400 constructed to hold up to 5 sample vials (e.g. 402-408) within an ultralow temperature environment. A variety of vial sizes and shapes can be accommodated in the cane (e.g. 410-418). In some examples, the cryovial cane 400 is constructed to hold a sample vial above a cooling medium in the ultralow temperature environment, and in other examples the vials are submerged within the cooling medium. In some embodiments, vial cages can be employed to hold a plurality of sample vials above, at, or within the cooling medium in the ultralow storage environment. Other known storage structures can also be used. Canes and cages can be constructed to hang from the top of an ultralow temperature storage container and a laboratory operator can lift the cage or cane in order to permit retrieval of a desired sample vial. The canes and cages can be constructed of varying sizes, lengths, etc. to permit place of sample vials at varying depths with an ultralow temperature storage container and to accommodate sample vials of various sizes. Some sample vials can be preserved within the cooling medium while others are stored above the cooling medium.

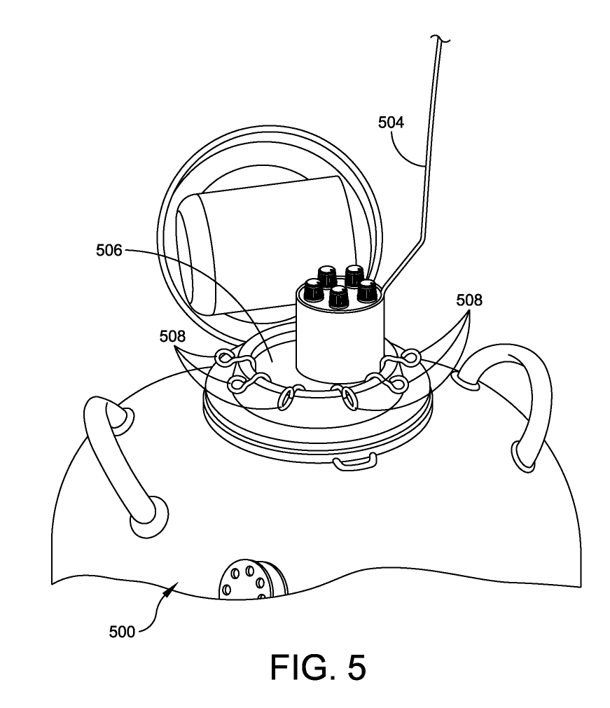

Shown by way of example, in FIG. 5 is an ultralow temperature storage tank 500. The storage tank 500 holds a volume of liquid phased nitrogen (not shown), which serves as the cooling medium for the ultralow temperature environment. During storage, cage 504 hangs off of the opening 506 of the storage tank 500. Multiple cages and/or canes can hang off of the opening at, for example, 508. The cages and/or canes can provide for storage in an easy accessed location.

In addition to vials having caps and containers, other sample storage devices can be employed and stored in canes and cages. Cryostraws are also commonly used in ultralow temperature environments for long term storage of biological samples. In some examples, embryonic and other fertility samples are stored in ultralow temperature environments using cryostraws. Cryostraws are characterized by having long thin bodies that form a tubular structure for housing a biological sample. The circumference and openings of the cryostraw are minimal compared to the length of the straw body. The length of the conventional cryostraw is typically many multiples of the circumference of the straw body. In one example, the dimensions of the cryostraw include a length of 133 mm and an internal diameter of an opening of 2.25 mm. The long length and small diameter of the opening provide a sample container with a high surface area to storage volume. The high surface to volume ratio of the cryostraw is known to improve homogenous heat exchange over the total volume of the straw. Conventional cryostraws come in a variety of configurations, and include different devices for managing and identifying the cryostraws in storage.

Cryostraws can be augmented for magnetic retrieval from an ultralow temperature environment by inserting a magnetic component into either a first or second end of the cryostraw. In some examples, both ends of a cryostraw can receive a magnetic component improving the ability to retrieve a cryostraw in the event of loss or misplacement. In one example, a ball magnet can be inserted into an open end of the cryostraw. In other examples, the magnetic component and/or the magnetic element can come in a variety of sizes and/or shapes. Some embodiments include cylindrical, spherical, ovular, elliptical, flat, and disk shaped magnetic components and/or magnetic elements. In another embodiment, an identification portion of the straw can be used to house a magnetic element.

According to one embodiment, a sample vial having a cylindrical body is provided. The cylindrical body can be open at both ends. The open ends can be first delivered sealed and cut open to permit introduction of a sample into a storage volume of the cylindrical body. The cylindrical body is long relative to the diameter of the cylindrical body. A typical diameter for the cylindrical body is approximately 2.25 mm with a body length of 90 or 133 mm. The open ends of the cylindrical body include a narrow aperture that extends through the cylindrical body defining the storage volume for the sample vial. The reference to long length of the cylindrical body is intended to include ranges between 80 to 160 mm, and is also intended to include a relative measure of length of at least 12 times the internal diameter of the narrow aperture. In some examples, the internal diameter of the narrow aperture can be up to 5 mm. The reference to narrow aperture is intended to include apertures with internal diameters of up to 6 mm.

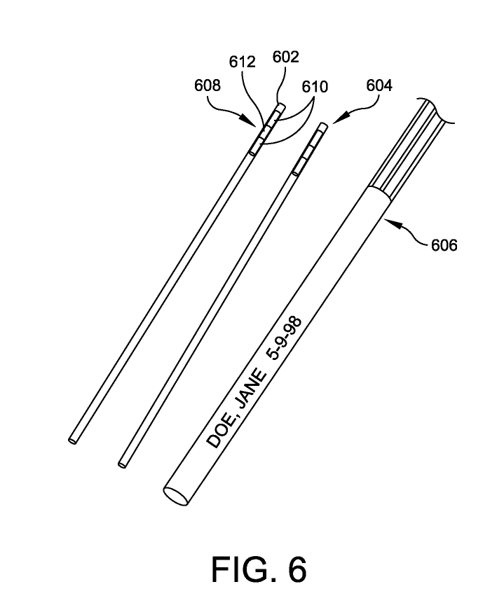

Shown in FIG. 6 are examples of cylindrical body sample vials known as cryostraws 602 and 604 which are used to hold biological samples in ultralow temperature environments. Multiple straws can be housed within a cane 606 or other known structures for long term storage in liquid nitrogen. Cryostraw 602 includes a sealable end 608 which is constructed with two air permeable plugs 610 and a powdered sealant 612 which reacts upon contact with a cryopreservant to seal the cryostraw. Cryopreservant is used when preparing a biological sample for storage in an ultralow temperature environment to minimize adverse impact on the sample due to the cooling process. The powdered sealant 612 turns into a gel upon contact with the cryopreservant. Other conventional cryostraws can include “high security” and “security” cryostraws which typically include additional plugs and/or inserts within the storage space to insure sterility of a preserved sample and improve freezing properties. Cryostraws of differing length, volume, and configuration are commercially available. These cryostraws can be augmented with magnetic components as discussed herein. Some examples of available cryostraws include:
CBS™ High Security sperm straw 0.3 ml with white cotton plug, reference nos. 010287 and 010288
CBS™ 0.3 ml embryo straw with hydrophobic plug with transparent filling nozzle pre-connected, reference no. 010286
CBS™ High Security tissue straw, reference no. 018960

Just as with sample vials having caps and containers, the misplacement of any cryostraw into the liquid nitrogen cooling medium can result in the loss of extremely valuable samples. Indeed, as the cryostraws are used for embryonic storage and other gonadal reproductive samples, the loss of a sample can be tragic. Thus, it becomes essential to recover lost cryostraws and any other preservation tubes/devices lost or misplaced in an ultralow temperature environment. All conventional types of sample storage containers for ultralow temperature environments can benefit from modification for magnetic retrieval.

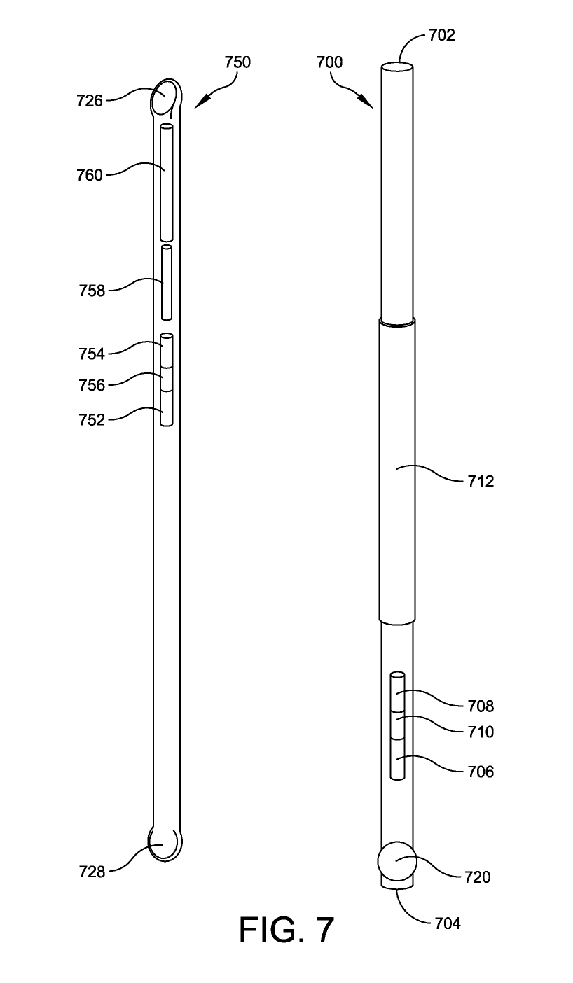

Shown in FIG. 7 are examples of cryostraws 700 and 750 configured for magnetic retrieval. Cryostraws 700 and 750 are examples of sample vials having a long cylindrical body and narrow apertures on either end of the cylindrical body. Cryostraw 700 includes a first 702 and second open end 704, which provide access to the storage volume of the cryostraw. The cryostraw also includes plugs 706 and 708 which hold a sealant 710 in place within the straw storage volume. The plugs can be made of fabric, for example cotton, that is permeable but keeps the sealant 756 in place. Other woven fibers and synthetic fibers can be used to construct plugs 706-708. Cryostraw 700 also includes a labeling sleeve 712 which assists in the management and identification of samples stored within an ultralow temperature environment. Shown at 720 is a magnetic component inserted into an open end of the cryostraw 700. Although one should appreciate that a magnetic component can be inserted into either end of the straw or both ends. Magnetic component 720 can be sized to pressure fit within the cryostraw. In some embodiments, the magnetic component 720 is sized to be larger than the opening 704 of the cryostraw 700. The body of the cryostraw distends in response to the insertion of the magnetic component 720, and the distended portion of the straw can hold the magnetic component in place.

In some embodiments, a cryopreservant and a sample are introduced into the storage volume of the cryostraw. The cryopreservant reacts with the sealant at 710 to seal one end of the straw. The other end may be sealed using the magnetic component 720. In the illustrated example, the magnetic component 720 is a spherical magnetic element. The spherical magnetic element can be constructed of a ferromagnetic material and/or a permanent magnet. The magnetic component can include a filler component (not shown) which can include resin, epoxy, or other composite material that can assist in sealing the cryostraw and/or holding the magnetic component in place within the cryostraw.

Shown at 750 is another example cryostraw. Cryostraw 750 includes plugs 752-754 and sealant 756. At 758 a cylindrical magnetic component is placed within the straw. The magnetic component can be constructed from a ferromagnetic material and/or a permanent magnet. The magnetic component can also include a filler component. In the embodiment illustrated at 750, the magnetic component does not need to pressure fit within the cryostraw as it is held in place by a sealed end of the cryostraw at 762 and plug 754. Cryostraw also includes a label insert 760, which permits various forms of labeling of the cryostraw for identification and/or management of cryostraw inventory. In some examples, label insert 760 can come in a variety of colors with individual colors used to identify common samples in a plurality of cryostraws. Once a sample has been drawn into the storage volume of the cryostraw any open end of the cryostraw can be sealed, at for example 728 and/or 726. Typically, conventional laboratory devices are available to apply heat and pressure to seal the ends of the cryostraw. The same or additional devices can be used to draw cryopreservant and biological samples into the storage volume of the cryostraw. In some settings, automated devices can assist in the transferring of biological samples and the sealing of the cryostraws.

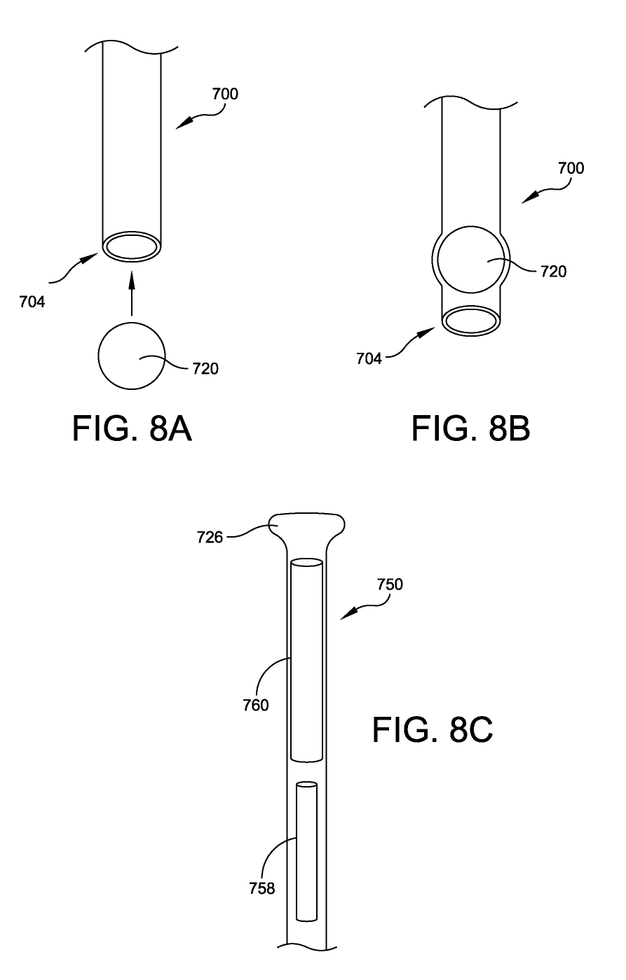

Shown in FIGS. 8A-C are illustrations of exploded views of straws 700 and 750. FIG. 8A illustrates opening 704 of straw 700 and magnetic component 720. FIG. 8B illustrates magnetic component 720 inserted through opening 704 into the body of the straw 700. FIG. 8C illustrates a label insert 760 and magnetic component 758 within the body of straw 750 at sealed end 726. In at least some embodiments, sample vial caps or straws include a magnetic component for aiding in the retrieval of sample vials. In some embodiment, the magnetic component is inserted within an opening of a cap or straw. In other embodiments, magnetic components can be used in other portions of a vial or straw, including under the cap, within the cap, at the bottom of vial, at the end of a straw, within the body of a straw, between or adjacent to one or more plugs within the body of a straw, among other locations.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any means, known now or later developed, for performing the recited function.

As used herein, whether in the written description or the claims, the terms “comprising”, “including”, “containing”, “characterized by” and the like are to be understood to be open-ended, i.e., to mean including but not limited to. Only the transitional phrases “consisting of” and “consisting essentially of”, respectively, shall be closed or semi-closed transitional phrases, as set forth, with respect to claims, in the United States Patent Office Manual of Patent Examining Procedures (Eighth Edition 2nd Revision, May 2004), Section 2111.03.

Use of ordinal terms such as “first”, “second”, “third”, “a”, “b” “c” etc., in the claims to modify or otherwise identify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A sample vial comprising:
a container configured to receive a sample, the container having a top portion; and
a cap configured to mate with the top portion of the container, the cap having a magnetic component.

2. The sample vial according to claim 1, wherein the magnetic component comprises:
a filler component; and
a magnetic element, wherein the magnetic component is constructed and arranged to fit within the cap of the sample vial.

3. The sample vial according to claim 1, wherein the mated container and cap are constructed and arranged to store a biological sample in an ultralow temperature environment.

4. The sample vial according to claim 1, wherein the cap further comprises:
a top surface; and
an outer wall having a circumference and a depth, wherein the circumference and the depth of the outer wall define a boundary of an opening on the top surface of the cap configured to receive the magnetic component.

5. The sample vial according to claim 4, wherein the magnetic component is constructed and arranged to fit within the boundary of the opening on the top surface of the cap.

6. The sample vial according to claim 5, wherein the magnetic component is constructed and arranged to removeably fit within the boundary of the opening on the top surface of the cap.

7. The sample vial according to claim 5, wherein the magnetic component further comprises at least one ventilation hole extending through the magnetic component.

8. The sample vial according to claim 2, wherein the filler component further comprises at least one of an epoxy, a composite resin, resin, polycarbonate material, acrylonitrile butadiene styrene, polyethylene foam, polypropylene foam, and a copolymer foam.

9. The sample vial according to claim 2, wherein the magnetic element comprises at least one of a ferromagnetic material and a permanent magnet.

10. A sample vial comprising:
a cylindrical body, having a first end and a second end, the first and second ends having a narrow aperture extending through the cylindrical body, wherein the cylindrical body has a long length relative to a diameter of the narrow aperture; and
a magnetic component contained in the cylindrical body.

11. The sample vial according to claim 10, wherein the narrow aperture extending through the cylindrical body defines a storage volume for the sample vial, wherein at least part of the storage volume is configured for receiving and storing a biological sample in an ultralow temperature environment.

12. The sample vial according to claim 10, wherein the magnetic component includes a magnetic element, and the magnetic element comprises at least one of a ferromagnetic material and a permanent magnet.

13. The sample vial according to claim 11, wherein the cylindrical body further comprises at least one plug positioned within the storage volume, wherein the at least one plug is permeable to air, and wherein the magnetic component is positioned between the at least one plug and one of the first and second ends of the cylindrical body.

14. The sample vial according to claim 14, wherein at least one of the first and second ends of the cylindrical body is constructed and arranged to be sealable using heat.

15. A method for retrieving sample vials from an ultralow temperature environment, the method comprising:
storing a biological sample in an ultralow temperature environment in a sealable sample vial, the sealable sample vial having a magnetic component; and
retrieving, by a human operator, at least one sealable sample vial from the ultralow temperature environment, wherein the act of retrieving includes an act of capturing the at least one sample vial employing the magnetic component.

16. The method according to claim 15, further comprising an act of inserting a magnetic component into at least one of a cap of the sealable sample vial and a sealable end of the sealable sample vial.

17. The method according to claim 16, wherein the act of inserting the magnetic component further comprises an act of distending a portion of the sealable sample vial.

18. The method according to claim 15, wherein the magnetic component further comprises at least one of a ferromagnetic material and a permanent magnet.

19. The method according to claim 15, wherein the act of capturing the at least one sealable sample vial includes an act of placing, by a human operator, a retrieval rod proximate to the at least one sample vial, wherein the retrieval rod includes a magnetic component.

20. The method according to claim 15, wherein storing the biological sample in the ultralow temperature environment in the sealable sample vial includes storing a plurality of sealable sample vials in holding structures within the ultralow temperature environment, and wherein retrieving the at least one sample vial from the ultralow temperature environment includes retrieving the at least one sealable sample vial from a position within the ultralow temperature environment outside of the holding structures.

21. A method for manufacturing magnetic sample vials, the method comprising:
providing a sample vial having an opening configured for storage of a biological sample in an ultralow temperature environment; and
inserting a magnetic component into the opening of the sample vial, wherein the magnetic component is constructed to fit within the opening.

22. The method according to claim 21, wherein the opening is defined in at least one of a cap of the sample vial and a sealable end of the sample vial.

23. The method according to claim 21, further comprising an act of fabricating the magnetic component based on a determined size of the opening.

24. The method according to claim 21, wherein the act of inserting the magnetic component includes fabricating the magnetic component within the opening.

25. The method according to claim 22, wherein the act of fabricating the magnetic component includes an act of combining a filler component and a magnetic element.

26. The method of claim 24, wherein the filler component includes at least one of an epoxy, a composite resin, resin, polycarbonate material, acrylonitrile butadiene styrene (ABS), polyethylene foam, polypropylene foam, and a copolymer foam and the magnetic element includes at least one of a ferromagnetic material and a permanent magnet.
